(19) United States
(12) Patent Application Publication
(10) Pub. No.: US 2025/0385048 A1
(43) Pub. Date: Dec. 18, 2025

(54) MULTILAYER ELECTRONIC COMPONENT

(71) Applicant: SAMSUNG ELECTRO-MECHANICS CO., LTD., Suwon-si (KR)

(72) Inventors: Jin Sung Chun, Suwon-si (KR); Won Woo Lee, Suwon-si (KR); Eun Ha Jang, Suwon-si (KR); Yun Ju Lee, Suwon-si (KR); Byung Sung Kang, Suwon-si (KR); Wi Hun Kim, Suwon-si (KR)

(73) Assignee: SAMSUNG ELECTRO-MECHANICS CO., LTD., Suwon-si (KR)

(21) Appl. No.: 19/073,707

(22) Filed: Mar. 7, 2025

(30) Foreign Application Priority Data
Jun. 18, 2024 (KR) 10-2024-0078744

(51) Int. Cl. H01G 4/30; H01G 4/012; H01G 4/232

(52) U.S. Cl. CPC H01G 4/30; H01G 4/012; H01G 4/232

(57) ABSTRACT

A multilayer electronic component includes a body having a dielectric layer and an internal electrode alternately stacked in a first direction. An external electrode is disposed on the body and connected to the internal electrode. A support member is disposed on at least one of the two opposing surfaces of the body in the first direction. The support member has a first end in contact with the external electrode and a second end opposite the first end, wherein the second end has a smaller thickness than the first end in the first direction.

### CROSS-REFERENCE TO RELATED APPLICATION(S)

This application claims benefit of priority to Korean Patent Application No. 10-2024-0078744 filed on Jun. 18, 2024 in the Korean Intellectual Property Office, the disclosure of which is incorporated herein by reference in its entirety.

### TECHNICAL FIELD

The present disclosure relates to a multilayer electronic component.

Multilayer ceramic capacitors (MLCCs), a type of multilayer electronic component, are chip-shaped capacitors that are mounted on the printed circuit boards of various electronic products such as video devices of Liquid Crystal Displays (LCDs) and Plasma Display Panels (PDPs), computers, smartphones, and mobile phones to charge or discharge electricity therein or therefrom. These MLCCs may be used as components of various electronic devices due to their advantages of being small, having high capacity, and being easy to mount.

Recently, the demand for MLCCs for automotive electronics has been rapidly increasing, and MLCCs for automotive electronics are often used in high-voltage environments. When high voltage is applied to MLCCs, the piezoelectric phenomenon in the dielectric material may cause deformation such as expansion of the MLCC body, and cracks may occur in the MLCC body due to this deformation.

Therefore, research into MLCCs that are highly reliable and possess high durability against deformation, even in high-voltage environments, is required.

### SUMMARY

An aspect of the present disclosure is to provide a multilayer electronic component having excellent reliability even in a high voltage environment.

According to an aspect of the present disclosure, a multilayer electronic component includes a body including a dielectric layer and an internal electrode, alternately disposed with the dielectric layer, in a first direction; an external electrode disposed on the body and connected to the internal electrode; and a support member disposed on at least one of two surfaces of the body opposing each other in the first direction. The support member has a first end contacting the external electrode and a second end opposite the first end, wherein the second end has a thickness thinner than a thickness of the first end in the first direction.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment;

FIG. 2 is a cross-sectional view schematically illustrating a section taken along line I-I′ of FIG. 1;

FIG. 3 is a cross-sectional view schematically illustrating a section taken along line II-II′ of FIG. 1;

FIG. 4 is a plan view schematically illustrating a multilayer electronic component according to an embodiment;

FIG. 5 is a plan view schematically illustrating a multilayer electronic component according to another embodiment, corresponding to FIG. 4;

FIG. 6 is a partially enlarged view schematically illustrating a Region K1 of FIG. 2;

FIG. 7 and FIG. 8 are partially enlarged views schematically illustrating a multilayer electronic component according to another embodiment and are drawings corresponding to FIG. 6;

FIG. 9A is a drawing illustrating displacement of a support member of a comparative example in a first direction and FIG. 9B is a drawing illustrating stress applied to a support member of a comparative example in a first direction, using a COMSOL analysis program; and

FIG. 10A is a diagram illustrating displacement of a support member of an embodiment in the first direction and FIG. 10B is a drawing illustrating stress applied to a support member of an embodiment in a first direction, using the COMSOL analysis program.

### DETAILED DESCRIPTION

Hereinafter, embodiments of the present disclosure will be described with reference to detailed embodiments and accompanying drawings. However, the embodiments of the present disclosure may be modified in many different forms, and the scope of the present disclosure is not limited to the embodiments described below. In addition, the embodiments of the present disclosure are provided to more fully describe the present disclosure to those skilled in the art. Therefore, the shapes and sizes of elements in the drawings may be exaggerated for clarity, and elements indicated by the same reference numerals in the drawings represent the same components.

In addition, to clearly describe the present disclosure in the drawings, parts irrelevant to the description are omitted, and the size and thickness of each component illustrated in the drawings are arbitrarily illustrated for convenience of description, and thus, the present disclosure is not necessarily limited to the illustrated embodiment. Also, components having the same function within the scope of the same concept are described using the same reference numerals. Furthermore, throughout the specification, when a certain component is said to “include,” it means that it may further include other components without excluding other components unless otherwise stated.

In the drawings, the first direction may be defined as the thickness (T) direction, the second direction may be defined as the length (L) direction, and the third direction may be defined as the width (W) direction.

### Multilayer Electronic Component

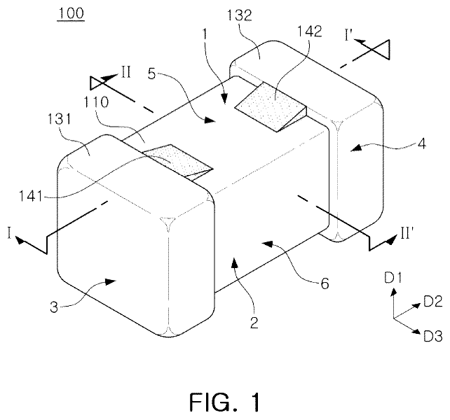

FIG. 1 is a perspective view schematically illustrating a multilayer electronic component according to an embodiment.

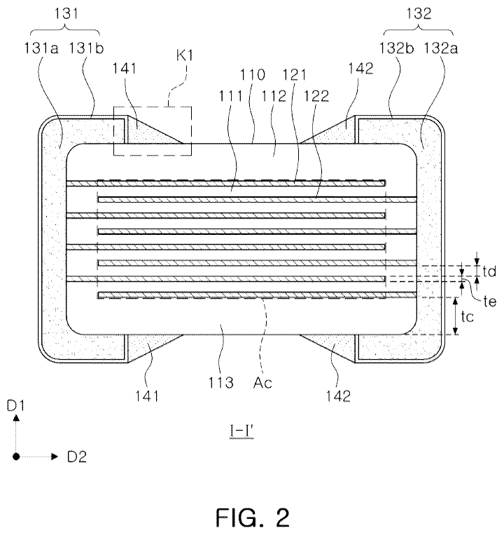

FIG. 2 is a cross-sectional view schematically illustrating a cross-section taken along line I-I′ of FIG. 1.

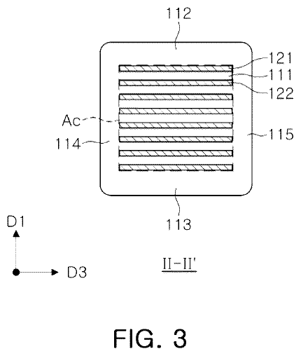

FIG. 3 is a cross-sectional view schematically illustrating a cross-section taken along line II-II′ of FIG. 1.

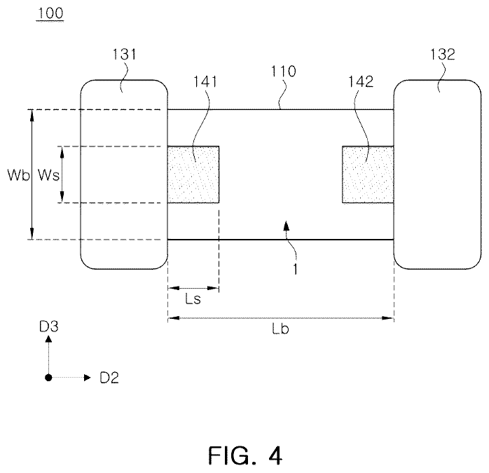

FIG. 4 is a plan view schematically illustrating a multilayer electronic component according to an embodiment.

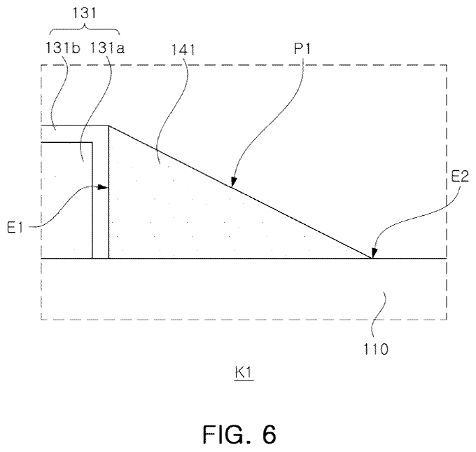

FIG. 6 is a partial enlarged view schematically illustrating a Region K1 of FIG. 2.

Hereinafter, a multilayer electronic component 100 according to an embodiment will be described in detail with reference to FIGS. 1 to 4 and FIG. 6. In addition, a multilayer ceramic capacitor will be described as an example of a multilayer electronic component; however, the present disclosure is not limited thereto and may also be applied to various multilayer electronic components, such as inductors, piezoelectric elements, varistors, and thermistors.

The multilayer electronic component 100 according to an embodiment may include a body 110, external electrodes 131 and 132, and support members 141 and 142.

The size of the multilayer electronic component 100 is not particularly limited; however, its maximum length in the second direction may range from 0.1 mm to 6.0 mm, its maximum width in the third direction may range from 0.1 mm to 5.0 mm, and its maximum thickness in the first direction may range from 0.05 mm to 3.5 mm.

There is no particular limitation on a detailed shape of the body 110, but as illustrated, the body 110 may be formed in a hexahedral shape or a similar shape. During a sintering process, the ceramic powder included in the body 110 shrinks, or due to a polishing process for the body 110 after the sintering process, the body 110 does not have a hexahedral shape with perfect straight lines, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3 and 4 and opposing each other in the third direction.

The body 110 may include a dielectric layer 111 and internal electrodes 121 and 122 alternately disposed with the dielectric layer 111 in the first direction. A plurality of dielectric layers 111 forming the body 110 are in a sintered state, and the boundary between adjacent dielectric layers 111 may be integrated to the extent that it is difficult to confirm without using a scanning electron microscope (SEM).

The dielectric layer 111 may include, for example, a perovskite compound represented by ABO₃ as a main component. The perovskite compound represented by ABO₃ may be, for example, BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, or (Ca₁₋ₓSrₓ)(Zr_{1-y}Ti_{y})O₃ (0<x≤0.5, 0<y≤0.5).

An average thickness td of the dielectric layer 111 is not particularly limited. The average thickness td of the dielectric layer 111 may range, for example, 0.1 μm to 20 μm, 0.1 μm to 10 μm, 0.1 μm to 5 μm, 0.1 μm to 2 μm, or 0.1 μm to 0.4 μm.

The internal electrodes 121 and 122 may include, for example, a first internal electrode 121 and a second internal electrode 122 that are alternately disposed in the first direction with the dielectric layer 111 interposed therebetween. The first internal electrode 121 and the second internal electrode 122, which are a pair of electrodes having different polarities, may be disposed to face each other with the dielectric layer 111 interposed therebetween.

The first internal electrode 121 may be spaced apart from the fourth surface 4 and connected to the first external electrode 131 on the third surface 3. The second internal electrode 122 may be spaced apart from the third surface 3 and connected to the second external electrode 132 on the fourth surface 4.

A conductive metal included in the internal electrodes 121 and 122 may include at least one of Ni, Cu, Pd, Ag, Au, Pt, Sn, W, Ti, and alloys thereof, and the internal electrodes 121 and 122 may include, for example, Ni, but the present disclosure is not limited thereto.

An average thickness the of the internal electrodes 121 and 122 is not particularly limited. The average thickness the of the internal electrodes 121 and 122 may range, for example, 0.1 μm to 3.0 μm, 0.1 μm to 1.0 μm, or 0.1 μm to 0.4 μm.

The average thickness td of the dielectric layer 111 and the average thickness the of the internal electrodes 121 and 122 refer to the average thicknesses of the dielectric layer 111 and the internal electrodes 121 and 122 in the first direction, respectively. The average thickness td of the dielectric layer 111 and the average thickness the of the internal electrodes 121 and 122 may be measured by scanning the first and second direction cross-section of the body 110 with a scanning electron microscope (SEM) at 10,000× magnification. In more detail, the average thickness td of the dielectric layer 111 may be measured by measuring the thicknesses at multiple points of one dielectric layer 111, for example, 30 equally spaced points in the second direction, and then taking an average value thereof. In addition, the average thickness the of the internal electrodes 121 and 122 may be measured by measuring the thicknesses at multiple points of one internal electrode 121 or 122, for example, 30 equally spaced points in the second direction, and then taking an average value thereof. The 30 equally spaced points may be designated in a capacitance forming portion Ac. Meanwhile, if these average value measurements are performed on 10 dielectric layers 111 and 10 internal electrodes 121 and 122 respectively and then the average values are measured, the average thickness td of the dielectric layer 111 and the average thickness the of the internal electrodes 121 and 122 may be further generalized.

The body 110 may include a capacitance forming portion (Ac) disposed inside the body 110 and including first and second internal electrodes 121 and 122 alternately disposed with the dielectric layer 111 therebetween to form capacitance, and cover portions 112 and 113 disposed on both surfaces of the capacitance forming portion Ac, opposing each other in the first direction. The cover portions 112 and 113 may have a similar configuration to the dielectric layer 111 except that they do not include the internal electrodes 121 and 122.

An average thickness tc of the cover portions 112 and 113 is not particularly limited. The average thickness tc of the cover portions 112 and 113 may be, for example, 300 μm or less, 150 μm or less, 100 μm or less, 30 μm or less, or 20 μm or less. The average thickness tc of the cover portions 112 and 113 may be, for example, 5 μm or more, 10 μm or more, or 30 μm or more. The average thickness tc of the cover portions 112 and 113 refers to the average thickness of each of the first cover portion 112 and the second cover portion 113.

The average thickness tc of the cover portions 112 and 113 refers to the average thickness of the cover portions 112 and 113 in the first direction, and may be an average value of the thicknesses in the first direction measured at five points equally spaced in the second direction in the first and second direction cross section of the body 110.

The body 110 may include margin portions 114 and 115 disposed on both sides of the capacitance forming portion Ac opposing each other in the third direction. The margin portions 114 and 115 refer to an area between both ends of the internal electrodes 121 and 122 and the boundary surface of the body 110 in the cross section of the body 110 cut in the first and third directions. The margin portions 114 and 115 may have a configuration similar to the dielectric layer 111 except that they do not include the internal electrodes 121 and 122.

The average width of the margin portions 114 and 115 is not particularly limited. The average width of the margin portions 114 and 115 may be, for example, 150 μm or less, 100 μm or less, 20 μm or less, or 15 μm or less. The average width of the margin portions 114 and 115 may be, for example, 5 μm or more, 10 μm or more, or 30 μm or more. In this case, the average width of the margin portions 114 and 115 refers to the average width of the first margin portion 114 and the second margin portion 115.

The average width of the margin portions 114 and 115 may refer to the average width of the margin portions 114 and 115 in the third direction, and may be an average value of the width in the third direction measured at five equally spaced points in the first direction, in the first and third direction cross section of the body 110.

Hereinafter, an example of a method of forming a body 110 is described.

First, ceramic powder for forming a dielectric layer 111 is prepared. The ceramic powder may be, for example, BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, or (Ca₁₋ₓSrₓ)(Zr_{1-y}Ti_{y})O₃ (0<x≤0.5, 0<y≤0.5). The BaTiO₃ powder may be synthesized, for example, by reacting a titanium raw material such as titanium dioxide with a barium raw material such as barium carbonate. The synthesis method of the above ceramic powder includes, for example, a solid-state method, a sol-gel method, a hydrothermal synthesis method, or the like, but the present disclosure is not limited thereto. Next, the prepared ceramic powder is dried and pulverized, after which an organic solvent and a binder are mixed to form a ceramic slurry. The ceramic slurry is then applied to and dried on a carrier film to produce a ceramic green sheet.

Next, an internal electrode conductive paste containing a metal powder, a binder, an organic solvent, and the like is printed on the ceramic green sheet to a predetermined thickness using a screen printing method, a gravure printing method or the like, thereby forming an internal electrode pattern.

Thereafter, the ceramic green sheet on which the internal electrode pattern is printed is peeled off from the carrier film, and then the ceramic green sheets on which the internal electrode pattern is printed are laminated and pressed in a predetermined number of layers to form a ceramic laminate. To form the cover portions 112 and 113 after sintering, a predetermined number of ceramic green sheets on which the internal electrode pattern is not formed may be laminated on the upper and lower portions of the ceramic laminate. Afterwards, the ceramic laminate may be cut to a predetermined chip size, and the cut chips may be sintered at a temperature between 1000° C. and 1400° C. to form the body 110. Afterwards, a barrel polishing process may be additionally performed to make the corners of the body 110 into a round shape.

Meanwhile, the margin portions 114 and 115 may be formed by sintering an area of the ceramic green sheet where the internal electrode pattern is not printed. Alternatively, to suppress the step caused by the internal electrodes 121 and 122, the ceramic laminate may be cut so that the internal electrode pattern is exposed on both sides of the cut chip in the third direction, and then a sheet for forming the margin portion may be attached on both sides of the cut chip in the third direction and then sintered to form the margin portions 114 and 115.

The external electrodes 131 and 132 may be disposed on the body 110 and connected to the internal electrodes 121 and 122. The external electrode 131 may include a first external electrode 131 disposed on the third surface 3 and extending over portions of the first and second surfaces 1 and 2, and a second external electrode 132 disposed on the fourth surface 4 and extending over portions of the first and second surfaces 1 and 2. The first and second external electrodes 131 and 132 may also extend onto portions of the fifth and sixth surfaces 5 and 6. The first external electrode 131 may be connected to the first internal electrode 121, and the second external electrode 132 may be connected to the second internal electrode 122.

The type or shape of the external electrodes 131 and 132 is not particularly limited, and may have a multilayer structure. For example, the external electrodes 131 and 132 may include base electrode layers 131a and 132a in contact with the internal electrodes 121 and 122 and plating layers 131b and 132b disposed on the base electrode layers 131a and 132a. For example, the first external electrode 131 may include a first base electrode layer 131a in contact with the first internal electrode 121 and a first plating layer 131b disposed on the first base electrode layer 131a, and the second external electrode 132 may include a second base electrode layer 132a in contact with the second internal electrode 122 and a second plating layer 132b disposed on the second base electrode layer 132a.

The base electrode layers 131a and 132a may be a sintered electrode layer including a first material that is a metal, and glass. The first material included in the base electrode layers 131a and 132a may include Cu, Ni, Pd, Ag, Pb, and/or alloys thereof, but the present disclosure is not limited thereto. The glass included in the base electrode layers 131a and 132a may include at least one oxide of Ba, Ca, Zn, Al, B, and Si, but the present disclosure is not limited thereto.

The base electrode layers 131a and 132a may be formed by dipping the body 110 into a conductive paste including a metal powder, glass frit, a binder, an organic solvent, and the like, and then sintering the conductive paste applied on the body 110.

Meanwhile, the base electrode layers 131a and 132a may be composed of only the first layer including metal and glass, but the present disclosure is not limited thereto, and the base electrode layers 131a and 132a may have a multilayer structure. For example, the base electrode layers 131a and 132a may comprise a first layer including metal and glass, and a second layer disposed on the first layer and including metal particles and resin.

The metal particles in the second layer may include at least one of spherical or flake-shaped particles. In this case, the spherical particles may also include a shape other than a perfect spherical shape, and may include, for example, a shape having a length ratio of the major axis to the minor axis (major axis/minor axis) of 1.45 or less. The flake-shaped particles refer to powder having a flat and elongated shape, and although not particularly limited, for example, the length ratio of the major axis to the minor axis (major axis/minor axis) may be 1.95 or more. The metal particles included in the second layer may include, for example, Cu, Ni, Ag, Sn, Pd, Pb, and/or alloys thereof. The resin included in the second layer may include, for example, at least one of epoxy resin, acrylic resin, and ethyl cellulose.

The second layer may be formed by applying a conductive resin composition including metal powder, resin, binder, organic solvent, and the like, on the first layer, and then performing a curing heat treatment at a temperature of, for example, 250° C. to 550° C.

The plating layers 131b and 132b may improve mounting characteristics. The plating layers 131b and 132b may include, for example, Ni, Sn, Pd, Cu, and/or alloys thereof, and may be formed as a plurality of layers. The plating layers 131b and 132b may be, for example, a Ni plating layer or a Sn plating layer, and may be formed in a form in which the Ni plating layer and the Sn plating layer are formed sequentially. In addition, the plating layers 131b and 132b may include multiple Ni plating layers and/or multiple Sn plating layers. The plating layers 131b and 132b may be formed, for example, using an electrolytic plating method and/or an electroless plating method.

Although the drawings illustrate a structure in which the multilayer electronic component 100 has two external electrodes 131 and 132, the present disclosure is not limited thereto, and the number or shape of the external electrodes 131 and 132 may be changed depending on the shape of the internal electrodes 121 and 122 or other uses.

The support members 141 and 142 may be disposed on at least one of two surfaces of the body 110 opposing each other in the first direction. The support members 141 and 142 may be disposed on the first and/or second surfaces 1, 2. The support members 141 and 142 may include first support members 141 that contact ends of a first external electrode 131 positioned on the first and second surfaces 1 and 2, and second support members 142 that contact ends of a second external electrode 132 positioned on the first and second surfaces 1 and 2.

When a high voltage is applied to the multilayer electronic component 100, the body 110 may expand in the first direction due to the piezoelectric phenomenon of the dielectric layer 111. Such deformation may cause cracks in the body 110, which may adversely affect the reliability of the multilayer electronic component 100. According to an embodiment of the present disclosure, the support members 141 and 142 are disposed on the first and/or second surfaces 1, 2 to suppress expansion of the body 110 and effectively disperse stress generated due to the piezoelectric phenomenon of the dielectric layer 111. As a result, the reliability of the multilayer electronic component 100 in a high-voltage environment may be improved. In addition, the support members 141 and 142 may prevent external moisture from penetrating into the body 110 by additionally sealing the ends of the external electrodes 131 and 132, which are the penetration paths of external moisture.

Referring to FIG. 6, the support member 141 may have a first end E1 that contacts the external electrode 131 and a second end E2 that faces the first end E1. According to one embodiment, the second end (E2) may be thinner in the first direction (hereinafter, simply referred to as thickness) than the first end (E1). Since the support member 141 has a structure in which the second end E2 is thinner than the first end E1, the effect of suppressing piezoelectric expansion of the body 110 for the same cross-sectional area may be excellent compared to the case in which the thickness of the support member 141 is constant.

In an embodiment, the support member 141 may have an inclined surface P1 inclined with respect to the first direction. The support member 141 may effectively disperse stress generated by piezoelectric expansion of the body 110 by having the inclined surface P1. The thickness of the support member 141 may gradually become thinner as it approaches the second end E2 from the first end E1, for example. For example, in the first and second direction cross section of the multilayer electronic component 100, the support member 141 may have a triangular shape. In the first and second direction cross-section of the multilayer electronic component 100, the inclined surface P1 may form a predetermined angle with the first end E1 and the lower surface of the support member 141, respectively.

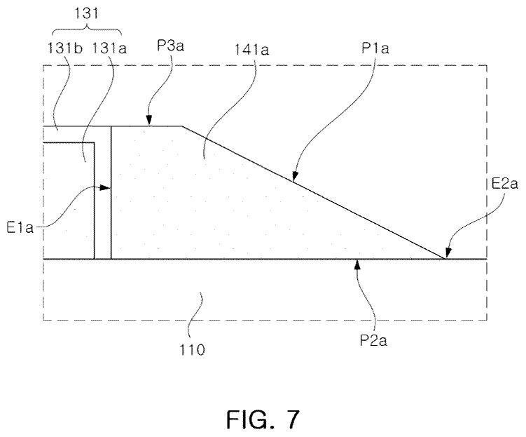

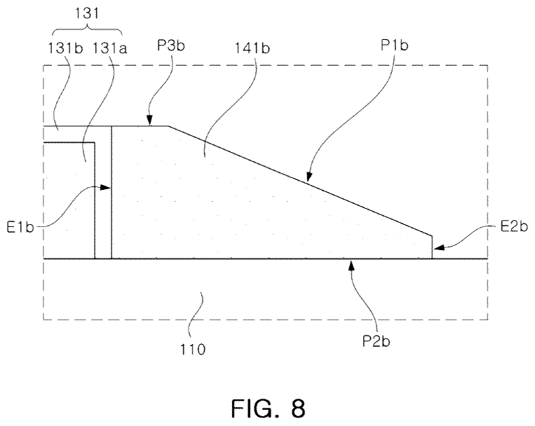

However, the shape of the support member 141 is not limited thereto, and may have various shapes. FIGS. 7 and 8 are partially enlarged views schematically illustrating a multilayer electronic component according to another embodiment, and are drawings corresponding to FIG. 6.

Referring to FIG. 7, the thickness of the second end E2a of a support member 141a may be thinner than the thickness of the first end E1a. The support member 141a may have an inclined surface Pla inclined with respect to the first direction. The inclined surface Pla of the support member 141a may not be in contact with the end of the external electrode 131. For example, in the first and second direction cross section of the multilayer electronic component, the support member 141a may have a trapezoidal shape. The support member 141a may have a lower surface P2a that contacts the body 110 and an upper surface P3a that faces the lower surface P2a, and the lower surface P2a may have a longer length in the second direction than the upper surface P3a. In the first and second direction cross section of the multilayer electronic component, the inclined surface P1a may form a predetermined angle with the lower surface P2a and the upper surface P3a, respectively.

Referring to FIG. 8, the thickness of the second end E2b of a support member 141b may be thinner than the thickness of the first end E1b. The support member 141b may have an inclined surface P1b that is inclined with respect to the first direction. The inclined surface P1b of the support member 141b may not contact the end of the external electrode 131. Unlike the second ends E2 and E2a of the aforementioned support members 141 and 141a, the second end E2b may have a thickness of a certain level or more. For example, in the first and second direction cross section of the multilayer electronic component, the support member 141b may have a pentagonal shape. The support member 141b may have a lower surface P2b in contact with the body 110 and an upper surface P3b facing the lower surface P2b, and the lower surface P2b may be longer in the second direction than the upper surface P3b. In the first and second direction cross section of the multilayer electronic component, the inclined surface P1b may form a predetermined angle with the second end E2b and the upper surface P3b, respectively.

Meanwhile, although not illustrated, the support members 141, 141a and 141b may have multiple inclined surfaces P1, P1a and P1b. To effectively suppress the piezoelectric expansion of the body 110, the inclined surfaces P1, P1a and P1b of the support members 141, 141a and 141b may, in detail, be flat, but the present disclosure is not limited thereto, and the inclined surfaces P1, P1a and P1b of the support members 141, 141a and 141b may be concave curved surfaces.

FIGS. 6 to 8 are partially enlarged views of the first support member 141, and there is only a difference between the first support member 141 being in contact with the first external electrode 131 and the second support member 142 being in contact with the second external electrode 132, but the first support member 141 and the second support member 142 may have substantially similar structures. Therefore, the description of the first support member 141 in FIGS. 6 to 8 may equally apply to the second support member 142.

Referring to FIG. 2, a maximum thickness of the first support member 141 in the first direction may be less than or equal to a maximum thickness of the first external electrode 131 in the first direction measured on the first or second surface 1 or 2, and a maximum thickness of the second support member 142 in the first direction may be less than or equal to a maximum thickness of the second external electrode 132 in the first direction measured on the first or second surface 1 or 2. The first support member 141 may not extend between the body 110 and the first external electrode 131, and the second support member 142 may not extend between the body 110 and the second external electrode 132. If the support members 141 and 142 extend between the body 110 and the external electrodes 131 and 132, a side effect such as an increase in the overall thickness of the multilayer electronic component 100 may occur.

In addition, the end of the first external electrode 131 positioned on the first or second surface 1 or 2 may not extend between the body 110 and the first support member 141, and the end of the second external electrode 132 positioned on the first or second surface 1 or 2 may not extend between the body 110 and the second support member 142. If the ends of the external electrodes 131 and 132 extend between the body 110 and the support members 141 and 142, a side effect such as an increase in the overall thickness of the multilayer electronic component 100 may occur.

Meanwhile, the body 110 may expand in the first direction and contract in the third direction due to the piezoelectric phenomenon of the dielectric layer 111. Therefore, the first and second support members 141 and 142 for preventing the body 110 from expanding in the first direction may not be disposed on the fifth and sixth surfaces 5 and 6.

A material included in the support members 141 and 142 is not particularly limited. However, to effectively suppress the piezoelectric expansion of the body 110, the support members 141 and 142 may include a second material having higher strength than the first material, which is a metal included in the base electrode layers 131a and 132a.

The second material may include a metal and/or a ceramic. When the second material includes a ceramic, the excellent strength of the support members 141 and 142 may effectively suppress the expansion of the body 110, but there is a disadvantage in that the support members 141 and 142 may be destroyed due to the brittleness of the ceramic when a certain level or more of stress is applied. On the other hand, when the second material includes a metal, there may be an advantage in that the support members 141 and 142 are not destroyed even when a certain level or more of stress is applied, due to the excellent ductility of the metal compared to the ceramic. The second material may include at least one of, for example, a Cu—Zn alloy, a Cu—Sn alloy, Fe, Si, and W.

A method of forming the support members 141 and 142 is not particularly limited. For example, the support members 141 and 142 may be formed by molding the second material into an intended shape and then attaching the same to the body 110. Therefore, the support members 141 and 142 may be composed of the second material, such as metal or ceramic. Unlike the base electrode layers 131a and 132a, the support members 141 and 142 are not formed through the sintering of a conductive paste, and therefore, the support members 141 and 142 may not include glass, a resin, and/or an organic material.

An adhesive layer may be disposed at the interface where the body 110 and the support members 141 and 142 come into contact. The adhesive layer may be, for example, a conductive and/or non-conductive tape, or may be formed by heat-treating a conductive paste. The adhesive layer may prevent the support members 141 and 142 from being detached from the body 110.

The size of the support members 141 and 142 is not specifically limited. For example, referring to FIG. 4, when the length of the support member in the second direction is Ls and the distance between the first external electrode 131 and the second external electrode 132 in the second direction is Lb, 0<Ls<0.5×Lb may be satisfied. In addition, when the width of the support member in the third direction is Ws and the width of the body 110 in the third direction is Wb, 0<Ws≤Wb may be satisfied. For example, as illustrated, Ws may be smaller than Wb, but the present disclosure is not limited thereto, and the support members 141 and 142 may be disposed over the entirety of the body 110 in the third direction.

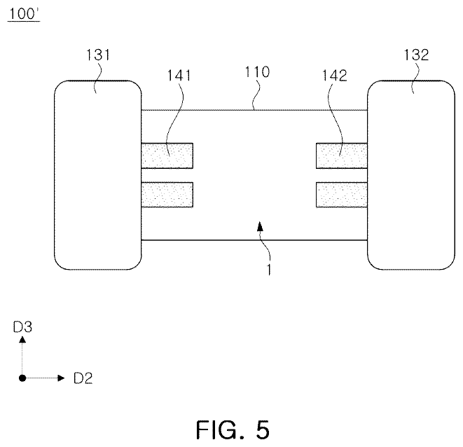

FIG. 5 is a plan view schematically illustrating a multilayer electronic component 100′ according to another embodiment, and is a drawing corresponding to FIG. 4.

Referring to FIG. 5, the first and second support members 141 and 142 may be disposed in plural, respectively. A plurality of first support members 141 may be arranged in the third direction, and a plurality of second support members 142 may also be arranged in the third direction. For example, the first and second support members 141 and 142 may be disposed in plural on the first surface 1, respectively, and the first and second support members 141 and 142 may also be disposed in plural on the second surface, respectively. Although FIG. 5 illustrates a structure in which the first and second support members 141 and 142 are disposed in two, respectively, the present disclosure is not limited thereto, and the number of first and second support members 141 and 142 may be appropriately selected without any particular limitation, taking into consideration the width of the body 110 in the third direction, or the like.

### EXPERIMENTAL EXAMPLE

To evaluate the deformation of a multilayer electronic component and the stress applied thereto according to the shape of the support member, a COMSOL analysis program was used.

The sample chip used in the analysis included a body, first and second external electrodes, and first and second support members (two on each of the upper and lower surfaces of the body, a total of four support members), and had a maximum length of 3 mm in the second direction and a maximum thickness of 2 mm in the first direction.

In the comparative example, the sample chip had a quadrangular shape where the thicknesses of the first and second ends of the support member were identical when viewed in the third direction. The sample chip according to an example of the present disclosure had a triangular shape in which the thickness of the second end was thinner than the thickness of the first end when viewed in the third direction. Meanwhile, both the sample chip according to the comparative example and the sample chip according to the example had a cross-sectional area of the support member of 0.5 cm² when viewed in the third direction. In detail, the maximum length of the support member of the comparative example in the second direction was 1 mm, and the maximum thickness thereof in the first direction was 0.5 mm; and the maximum length of the support member of the example in the second direction was 1 mm, and the maximum thickness thereof in the first direction was 1 mm.

Thereafter, to assume the piezoelectric expansion situation of the dielectric layer occurring when a high voltage is applied, when a load of 1 N is transmitted from the upper and lower surfaces of the body toward the support members, the displacement of the support member in the first direction and the stress applied to the support member in the first direction were measured using the COMSOL analysis program.

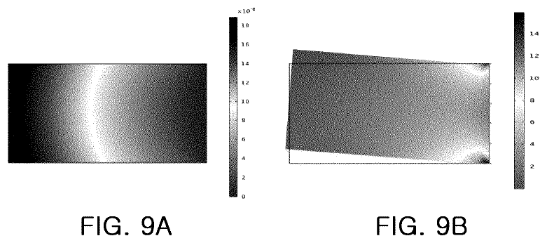

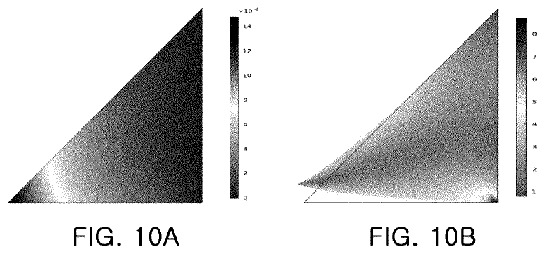

FIGS. 9A and 9B illustrate (a) the displacement of the support member in the comparative example in the first direction and (b) the stress applied to it in the first direction, as analyzed using the COMSOL analysis program. FIGS. 10A and 10B are drawings illustrating (a) the displacement of the support member of the example in the first direction and (b) the stress applied to the support member of the example in the first direction, using the COMSOL analysis program. For example, FIG. 9A and FIG. 10A only illustrate the degree of deformation of the support member by location in color, and FIG. 9B and FIG. 10B illustrate the deformed form of the support member, but illustrate the stress applied to the support member by location in color.

As a result of the COMSOL analysis, in the sample chips of the comparative example and the example, the point where the displacement of the support member in the first direction was maximum was near the second end (the left end in the images of FIGS. 9A and 10A), and the point where the stress applied to the support member in the first direction was maximum was near the first end (the right end in the images of FIGS. 9B and 10B).

In the comparative example, a maximum displacement of the support member in the first direction was 1.89×10⁻⁷ cm, and a maximum stress applied to the support member was 15.6 N/m². Conversely, in the example of the present disclosure, a maximum displacement of the support member in the first direction was 1.48×10⁻⁷ cm, and a maximum stress applied to the support member was 8.7 N/m².

For example, since the example of the present disclosure has a structure in which the thickness of the second end is thinner than the thickness of the first end, it can be confirmed that the effect of suppressing the piezoelectric expansion of the body relative to the same cross-sectional area is excellent compared to the comparative example with a constant thickness.

As set forth above, as an effect of the present disclosure, a multilayer electronic component having excellent reliability even in a high-voltage environment may be provided.

The present disclosure is not limited by the above-described embodiments and accompanying drawings, but is intended to be limited by the appended claims. Therefore, various forms of substitution, modification and change will be possible by those skilled in the art within the scope of the technical spirit of the present disclosure described in the claims, and this will also be said to fall within the scope of the present disclosure.

In addition, the expression ‘an embodiment’ does not indicate the same embodiment, and is provided to emphasize and describe different unique characteristics. However, the embodiments presented above are not excluded from being implemented in combination with features of another embodiment. For example, even if a matter described in one specific embodiment is not described in another embodiment, it may be understood as a description related to another embodiment, unless there is a description to the contrary or contradicting the matter in another embodiment.

In addition, expressions such as first and second are used to distinguish one component from another, and do not limit the order and/or importance of the components. In some cases, without departing from the scope of rights, a first element may be named a second element, and similarly, a second element may be named a first element.

While example embodiments have been described above, those skilled in the art will recognize that modifications and variations may be made without departing from the scope of the present invention, as defined by the appended claims.

What is claimed is:

1. A multilayer electronic component comprising:
a body including a dielectric layer and an internal electrode, alternately disposed with the dielectric layer, in a first direction;
an external electrode disposed on the body and connected to the internal electrode; and
a support member disposed on at least one of two surfaces of the body opposing each other in the first direction,
wherein the support member has a first end contacting the external electrode and a second end opposite the first end, and
the second end has a smaller thickness than a thickness of the first end in the first direction.

2. The multilayer electronic component of claim 1, wherein the support member has an inclined surface forming an angle with the first direction.

3. The multilayer electronic component of claim 1, wherein a thickness of the support member in the first direction gradually decreases from the first end toward the second end.

4. The multilayer electronic component of claim 1, wherein the external electrode is in contact with the internal electrode and includes a base electrode layer comprising a first material, a metal, and
the support member comprises a second material with a strength greater than a strength of the first material.

5. The multilayer electronic component of claim 4, wherein the second material comprises at least one selected from the group consisting of a Cu—Zn alloy, a Cu—Sn alloy, Fe, Si, and W.

6. The multilayer electronic component of claim 4, wherein the second material comprises a ceramic.

7. The multilayer electronic component of claim 1, wherein the body includes a first surface and a second surface opposing each other in the first direction, a third surface and a fourth surface connected to the first and second surfaces and opposing each other in a second direction, and a fifth surface and a sixth surface connected to the first to fourth surfaces and opposing each other in a third direction,
the external electrode includes a first external electrode disposed on the third surface and extending onto portions of the first and second surfaces, and a second external electrode disposed on the fourth surface and extending onto portions of the first and second surfaces, and
the support member includes a first support member in contact with an end of the first external electrode located on the first and second surfaces, and a second support member contacting an end of the second external electrode located on the first and second surfaces.

8. The multilayer electronic component of claim 7, wherein a maximum thickness of the first support member in the first direction is equal to or less than a maximum thickness of the first external electrode in the first direction, measured on the first or second surface, and a maximum thickness of the second support member in the first direction is equal to or less than a maximum thickness of the second external electrode in the first direction, measured on the first or second surface, and
the first support member does not extend between the body and the first external electrode, and the second support member does not extend between the body and the second external electrode.

9. The multilayer electronic component of claim 7, wherein the first and second support members are not disposed on the fifth and sixth surfaces.

10. The multilayer electronic component of claim 7, wherein the first and second support members are each disposed in plural.

11. The multilayer electronic component of claim 1, wherein an interface at which the body and the support member come into contact is further provided with an adhesive layer.

12. The multilayer electronic component of claim 1, wherein the external electrode includes a base electrode layer in contact with the internal electrode and a plating layer disposed on the base electrode layer.

13. The multilayer electronic component of claim 12, wherein the base electrode layer comprises a first layer including a metal and a glass, and a second layer disposed on the first layer and including metal particles and a resin.

14. A multilayer electronic component comprising:
a body including a dielectric layer and an internal electrode, alternately stacked with the dielectric layer in a first direction;
an external electrode disposed on the body and connected to the internal electrode;
a support member disposed on at least one of two opposing surfaces of the body in the first direction; and
an adhesive layer provided at an interface between the support member and the body,
wherein the support member has a first end contacting the external electrode and a second end opposite the first end, and
the second end has a smaller thickness than a thickness of the first end in the first direction.

15. The multilayer electronic component of claim 14, wherein the adhesive layer comprises at least one of a conductive paste, or a non-conductive tape.
